(19) United States
(12) Patent Application Publication
(10) Pub. No.: US 2011/0182473 A1
(43) Pub. Date: Jul. 28, 2011

(54) SYSTEM AND METHOD FOR VIDEO SIGNAL SENSING USING TRAFFIC ENFORCEMENT CAMERAS

(75) Inventor: Jigang WANG, Scottsdale, AZ (US)

(73) Assignee: American Traffic Solutions, Inc. of Kansas, Scottsdale, AZ (US)

(21) Appl. No.: 13/015,609

(22) Filed: Jan. 28, 2011

Related U.S. Application Data
(60) Provisional application No. 61/298,948, filed on Jan. 28, 2010.

(51) Int. Cl. G06K 9/00; H04N 7/18

(52) U.S. Cl. 382/103; 348/143; 348/E07.085

(57) ABSTRACT

A system and method for determining the state of a traffic signal light, such as being red, yellow, or green, by employing a plurality of traffic enforcement cameras to be used in determining if a traffic violation has occurred. The system and method automatically predicts, tacks and captures violation events, such as violating a red traffic signal light, to use the video for any number of reasons, particularly for traffic enforcement purposes. There may be provided a tracking camera, a signal camera and an enforcement camera used to capture the video and other pertinent information relating to the event. The signal camera may be operatively connected to a processing unit that runs a video signal sensing (VSS) software unit to determine the active state of the system. Advantageously, this allows the monitoring of intersection for signal light violations without the need for a connection to the light itself.

This application claims the benefit of U.S. Provisional Application No. 61/298,948, filed Jan. 28, 2010, the content of which is incorporated by reference herein and relied upon.

### COPYRIGHT & LEGAL NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### FIELD OF THE INVENTION

The present invention relates generally to the field of automated systems and methods for traffic enforcement and more particularly to the acquisition of video files in connection with traffic signal light violations.

### BACKGROUND OF THE INVENTION

In the field of traffic enforcement, there exist a variety of systems and methods for acquiring and capturing data related to a traffic violation event, such as the capture of a video of the violation event, as well the acquisition and delivery of other information about the traffic violation itself. The traffic violation may be any action that violates an operating law and more particularly, that violates a traffic signal light, such as a red light traffic violation, by traveling through an intersection in violation of the traffic light (i.e., after the light has already turned red).

It is desirable to detect, capture and store violation events via roadside traffic enforcement cameras, or other imaging devices. For example, when tracking a red light violation, it is desirable to capture a video of the violation, as well as any relevant information such as the location of the violation, the date, the duration of the violation, information identifying the violating vehicle and/or operator and any other pertinent information useful in proving that the violation occurred, such as the state of the traffic light signal.

According to current traffic enforcement systems, determination of traffic signal states (i.e. the color of the traffic light—red, yellow or green) is achieved using electronic devices that are electronically connected to the traffic light system and/or its controller. Such enforcement systems can sense the presence of absence of power being transmitted to a traffic signal head. For example, a module may be connected to a traffic signal input to measure the presence or absence of power to each signal disc. However, this method typically requires direct wiring between the traffic signal input and the traffic enforcement module to measure the presence or absence of power. Traffic signal controllers may vary greatly. Thus, it may prove difficult to provide a wired interface that accommodates the majority of light systems without the need for significant customization. Such custom installation increases the costs of providing an enforcement system.

Various attempts have been made to overcome the need for a hardwired connection between the signal and the enforcement system, such as providing an inductive toroidal coil, placed around the electrical wire that feeds each signal disc, to measure the presence of absence of power. However, this still requires a connection to the target traffic signal to determine the state of the signal. This requirement of a connection to the signal head, directly or indirectly, becomes even more problematic when the connections are either prohibited by law or made impossible or costly to due physical restraints. Connecting to a traffic signal light head to determine its state clearly has its disadvantages.

It is therefore highly desirable to provide a system and method for determining traffic signal states without requiring a wired connection to the traffic signal or need to sense the electrical state of the signal wiring. This approach should improve automated traffic enforcement by enabling intersections to be monitored without the need to hardwire into, or form another type of direct connection or communication with, the traffic light control system. In this manner, an intersection may be monitored once the enforcement cameras and associated enforcement system components are installed, without the need for additional connections to the traffic light signal itself.

### SUMMARY OF THE INVENTION

This invention overcomes disadvantages of the prior art by providing a system and method for determining the state (e.g. red, green, yellow, red arrow, green arrow, etc.) of a traffic signal light using traffic enforcement cameras that are free of interconnection, wired or otherwise, to the controllers or wiring of the traffic signal system. In general, the invention herein provides a system and method for automatically predicting, tracking and capturing traffic violation events in which the traffic enforcement cameras include a signal camera provided to transmit images to a video signal sensing software module so that they can be used to determine the state of the traffic signal. This data can be used in compiling the overall information relating to the traffic violation, such as for generating a citation of the violation that includes images of the violation.

In an illustrative embodiment, there is provided a system and method for acquiring pertinent information related to a traffic violation event. More particularly, the system and method employs one traffic enforcement camera to capture a video file of the traffic signal violation event, while simultaneously employing a signal camera that provides images to a signal sensing module that employs machine vision search techniques to determine the state of the traffic signal. The method first monitors a particular roadside area for traffic violations. For example, there may be a plurality of video cameras each having a respective, discrete view of an intersection that is being monitored for, by way of example, a red light traffic violation. A prediction algorithm is employed to determine if a vehicle is a potential violator, and if so, a video of the violation is captured. Simultaneously, a signal video camera according to an illustrative embodiment captures images of the traffic signal light head, and transmits the images to a processing unit that runs a video signal-sensing software module to determine the active state of the light.

In the illustrative embodiment, the state (i.e., red, yellow or green) of the traffic signal is determined utilizing the hue, brightness, color intensity, shape and temporal changes detected by a traffic enforcement camera employing machine vision search techniques. Each of these factors are weighted differently according to a video signal-sensing algorithm or process to determine the active state of the video signal as being red, yellow or green.

Combining the state of the traffic light with the violation video creates a piece of evidence that is used to verify the violation of the traffic light. This information may be reviewed by traffic enforcement personnel to issue warnings and/or citations accordingly. When a citation is issued, these images may be provided directly thereon to automatically issue the citation having direct proof of the violation.

### BRIEF DESCRIPTION OF THE DRAWINGS

The invention description below refers to the accompanying drawings, of which:

FIG. 1 is a top view of an exemplary intersection of two roads, employing a video signal sensing (VSS) system for traffic enforcement according to an illustrative embodiment;

FIG. 2 is a top view of an intersection of two roads, particularly detailing a tracking camera of the illustrative VSS system for traffic enforcement;

FIG. 3 is an exemplary view as imaged by the tracking camera of FIG. 2;

FIG. 4 is a top view of an intersection of two roads, showing one embodiment of a signal camera of the illustrative VSS system for traffic enforcement, employing a single camera to sense the video signal;

FIG. 5 is an exemplary view as imaged by the signal camera of FIG. 4;

FIG. 6 is a top view of an exemplary intersection of two roads, particularly showing the enforcement camera of the illustrative VSS system for traffic enforcement;

FIG. 7 is an exemplary view as imaged by the enforcement camera of FIG. 6;

FIG. 8 is a top view of an intersection of two roads employing two cameras for the signal camera of the VSS system, according to an alternate embodiment; and

FIG. 9 is a flow diagram of a procedure for determining the state of the traffic signal employed by the VSS module according to an illustrative embodiment.

### DETAILED DESCRIPTION OF THE PREFERRED EMBODIMENT(S)

In accordance with the present invention there is provided a video signal sensing system and method for the prediction, tracking and capturing of a video and other information related to a traffic violation event. More particularly, there is provided a system and method for acquiring and capturing information related to a traffic signal light violation, such as a red light violation, using traffic enforcement cameras to sense a video signal. A “red light violation” as used herein occurs when a vehicle passes the stop line when the designated traffic signal is red and then it continues to cross through the intersection.

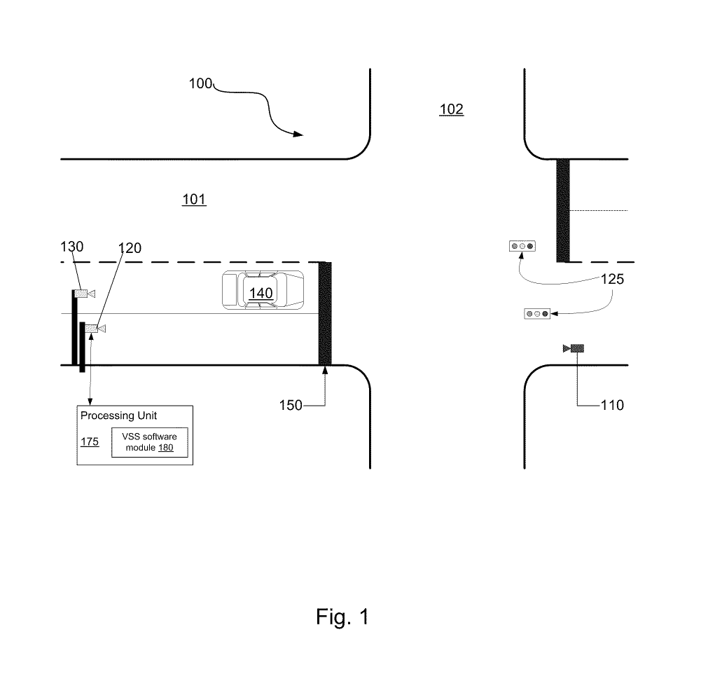

Referring now to FIG. 1, a top view of an exemplary intersection 100 of two roads, road 101 and road 102, is shown employing a system utilizing the illustrative video signal sensing (VSS) system for traffic enforcement. Note that for clarity, in the exemplary intersection 100, each road comprises two lanes to be tracked for traffic enforcement purposes. However, it is expressly contemplated that any number of lanes may be monitored using the illustrative VSS system, including a single-lane road or a more complex multi-lane road intersection. The system is capable of monitoring at least five lanes (on each side of the road) using a single set of traffic enforcement cameras.

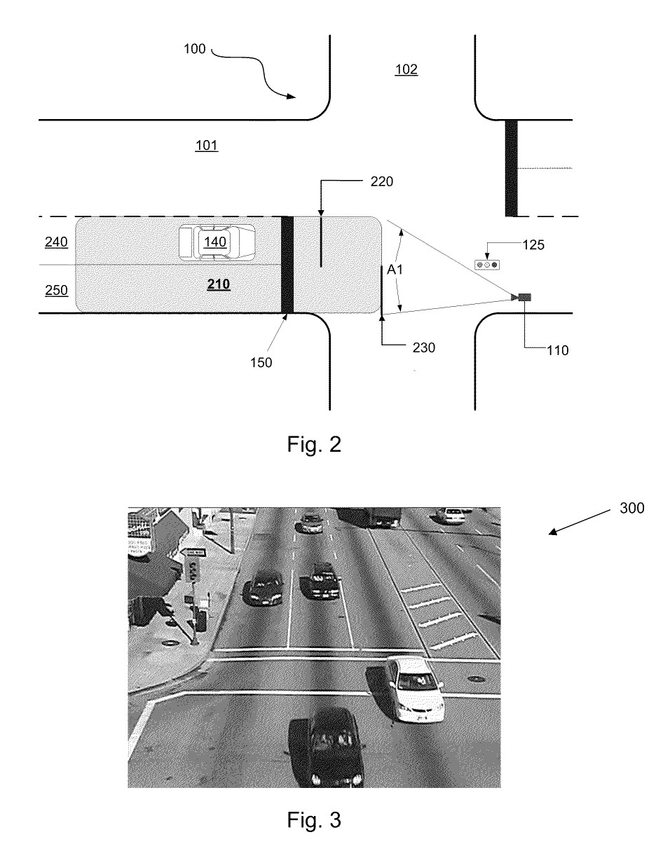

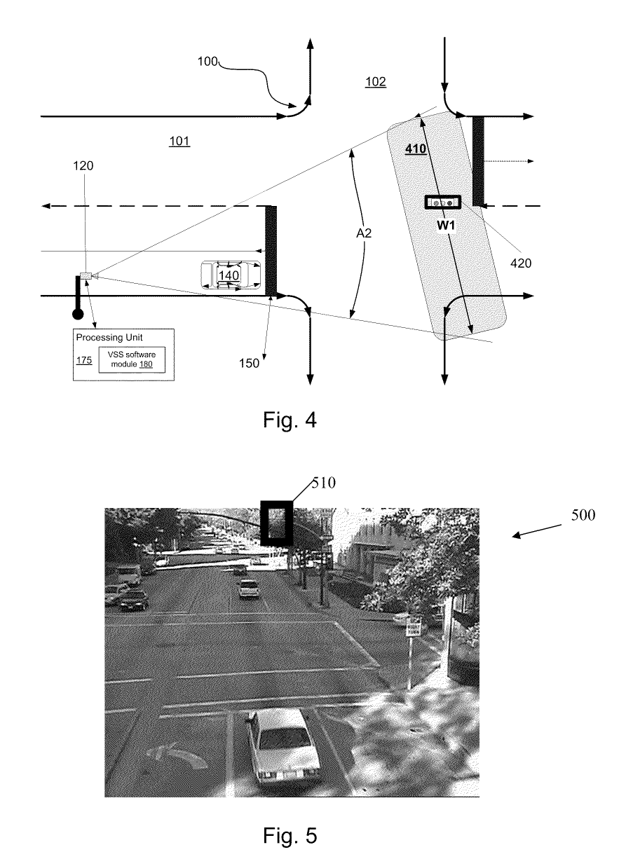

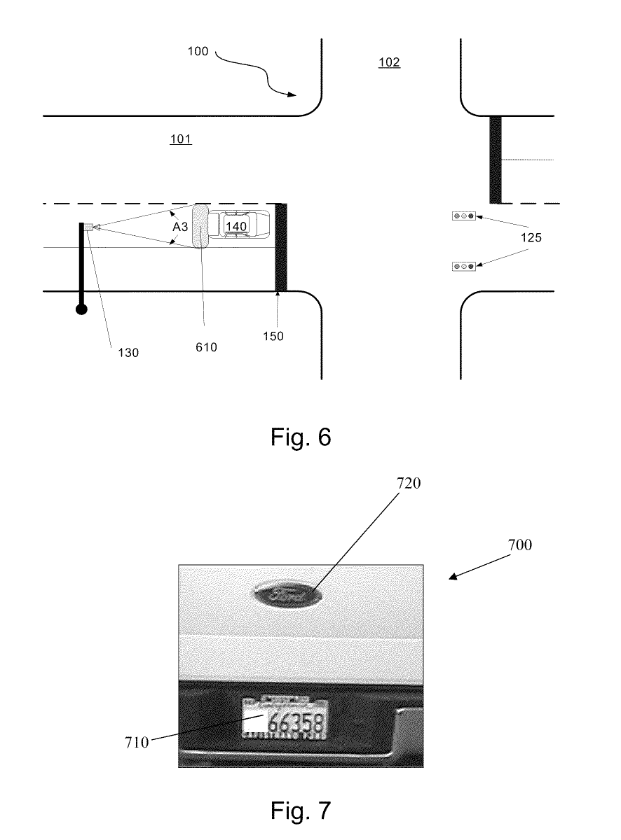

The system employs a plurality of traffic enforcement cameras including a tracking camera 110, a signal camera 120 and an enforcement camera 130 to monitor the intersection 100 for possible violations. The tracking camera 110, as described in greater detail below with particular reference to FIGS. 2 and 3, is directed toward a travel lane approaching an intersection to view the front of a potentially violating vehicle at it enters the intersection. This allows the enforcement system to track the progress of a vehicle as it enters the intersection and to determine if a violation is likely to occur. The signal camera 120, described in further detail below with reference to FIGS. 4, 5 and 8, is directed so as to image the traffic light signal 125 and thereby to determine the current state (e.g. red, yellow, green, etc.) of the traffic light. Notably, the signal camera allows the state of the traffic signal 125 to be determined in a manner that is free of an additional connection to the traffic signal light 125, as will be described in greater detail hereinafter. Further, the enforcement camera 130, described in greater detail hereinafter with reference to FIGS. 6 and 7, is directed so as to image the rear of the vehicle to capture pertinent information about the violation vehicle, to be used for traffic enforcement purposes. This information can include a license plate and the make/model of the vehicle.

As shown in FIG. 1, an exemplary vehicle 140 is approaching the intersection 100. Concurrently, as the vehicle approaches the stop line 150, the signal camera detects the signal 125 within its field of view, to determine the state of the signal 125. If a red light state is detected, as will be described in greater detail below, the tracking camera 110 determines whether an approaching vehicle is likely to violate the red light by continuing to travel through the intersection, based on factors such as speed and distance, among others. By way of background, a more detailed description of an illustrative process by which the system performs the prediction, tracking and capturing of traffic violation information, is provided in commonly assigned U.S. Pat. No. 6,754,663, entitled VIDEO-FILE BASED CITATION GENERATION SYSTEM FOR TRAFFIC LIGHT VIOLATIONS, which is expressly incorporated by reference herein.

An illustrative system employs environmentally sealed/protected pan, tilt, zoom and fixed mount video cameras mounted on existing traffic signal poles or additional poles provided at an intersection, onto which the cameras are mounted. These video cameras are the only devices required to perform the gathering of traffic enforcement evidence, as the video signal sensing is performed by a camera to detect a violation.

Referring again to FIG. 1, once the system determines that a violation is likely to occur, the tracking camera captures a video of the violation. It records the vehicle approaching the stop line and continuing through the intersection from a point of view as observed from across the intersection. Simultaneously, the signal camera 120 determines the state of the traffic signals, using conventional, commercially available machine vision search techniques, to ascertain the state without the need for hard wiring into the traffic light signal.

As will be discussed in further detail below, a variety of techniques can be employed to determine the light state. Some techniques can employ color identification, discerning between a bright contrasting field of red, green or yellow appearing within the overall field of view of the signal camera 120. Since the camera 120 and signal(s) are fixed with respect to each other, the signal camera 120 can be adapted and/or set to image a box that defines a narrow field around each signal so as to avoid fake readings from, for example the sun or a streetlight. Likewise, the vision system can search for particular ranges of wavelengths that are specifically characteristic of the particular signal colors. In an alternate, or complimentary technique, the vision system is trained to determine whether a high-contrast brightness (grayscale, for example) appears in the top, middle, or bottom part of the signal's field of view, representing the appropriate signal state. In such systems, the color detection can be substituted with grayscale detection which determines levels of brightness rather than different colors.

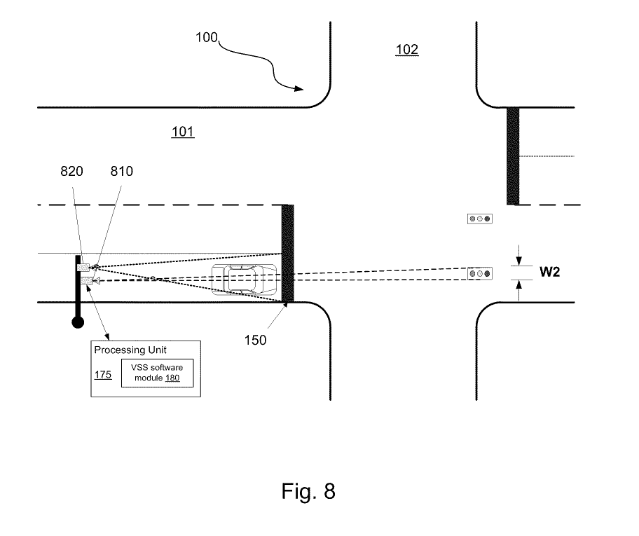

According to this embodiment, a single camera is used for the signal sensing of the illustrative system. This single camera has a view of the entire intersection, including the signal lights. As will be described in reference to FIG. 8, the system may employ two cameras for sensing the signal, having one camera dedicated to viewing the traffic light head specifically. This camera records the vehicle and a view of the signal as the vehicle is traveling past the stop line 150 after the light is red and continues through the intersection 100 from behind the stop line.

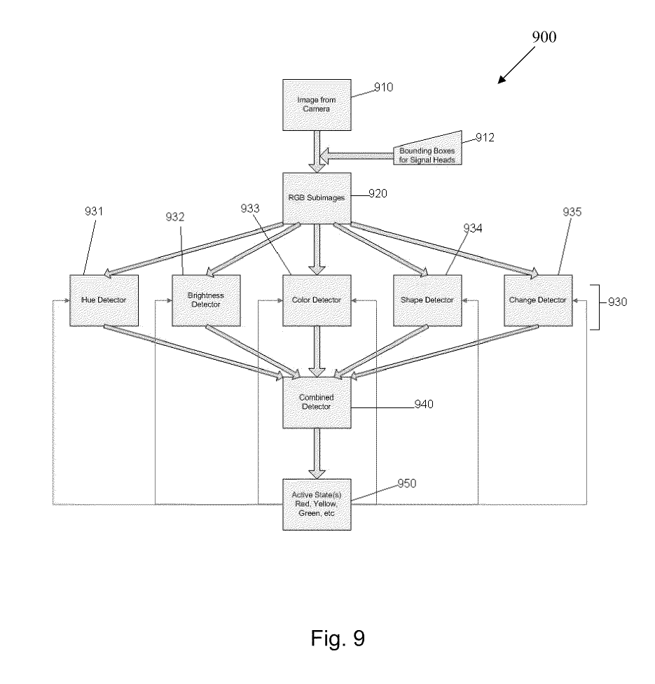

The signal camera 120 transmits a video as input to a processing unit 175 having a video signal sensing (VSS) software module 180 thereon. The processing unit 175 receives a video input from the signal camera 120 and then runs the VSS software module 180 to determine the active state of the system. The method for implementing this is described below with reference to FIG. 9, which shows the procedure steps according to the illustrative VSS method.

Also shown in FIG. 1 is the enforcement camera 130, which obtains a rear view of a vehicle 140 (a view from behind the vehicle, as shown in FIG. 6) approaching the intersection as it travels along road 101. This camera zooms in on the vehicle after the stop line to obtain the license plate of the violating vehicle and enough detail to determine the make of the vehicle, as will be described in greater detail below. As will also be described in greater detail below, the enforcement camera 130, in an alternate embodiment, may be located at the opposite side of the intersection to obtain a video of the front of the vehicle and then swing around to obtain a video of the rear of the violating vehicle. In this manner, an image of both the front and rear license plates of the violating vehicle is obtained.

Referring now to FIG. 2, a top view of an intersection is shown employing the VSS system of an embodiment of the invention, and showing only the tracking camera 110 of FIG. 1 by way of illustration. The tracking camera 110 projects in an approximate arc A1, to provide a field of view approximately equivalent to the area of the dotted region 210. The tracking field of view 210 provides an image of the intersection as required for performing the prediction and tracking of each vehicle that enters the intersection. The purpose of the tracking camera is to allow the tracking software to continuously view and image (i.e. provide a plurality of tracking images) all approaching vehicles in the monitored lanes. This image is used as part of the context recording, to create the body of evidence used in a traffic enforcement action against a violator. When combined with the other pertinent data relating to the violation, a piece of evidence may be automatically created for traffic enforcement purposes.

In an illustrative embodiment, the tracking camera is placed at an optimal location such that it provides a clear image of the tracking field of view (shaded area 210), preferably to a view from approximately 100 feet before the stop line to 20 feet after the stop line. During installation, the camera 110 should be placed at a location that is 32 to 38 feet from the ground, as the higher the camera is placed, typically the view of the violation area is improved. However, the location of the camera 110 can be varied as required to adapt to each location and/or intersection. It is typically desirable that the tracking camera be located no more than approximately 50 feet from the stop line to provide a clear and accurate view of the intersection 100.

Generally, the system employs at least one prediction unit responsible for predicting potential traffic violations and at least one violation unit in communication with the prediction unit for recording the violations. A prediction unit processes each video captured by a prediction camera so as to identify predicted violators. The prediction unit then sends a signal to the violation unit if it finds a high probability of violation events. The violation unit then records the high probability events. As previously described a more detailed discussion of the methods and systems for performing the prediction and tracking of traffic violation events, is found, for example, in commonly assigned U.S. Pat. No. 6,754,663.

Also shown in FIG. 2 are exemplary virtual violation lines 220 and 230, used to determine potential violators. The virtual violation line 220 is defined for lane 240, and used to determine if a vehicle traveling in that lane is likely to violate the traffic light signal, and the virtual violation line 230 is for lane 250 and used to determine the likelihood of a violation in that lane. These virtual violation lines employ a filter to eliminate potential violations that are not likely. By way of background, a more detailed description of this implementation, is provided in commonly assigned U.S. Pat. No. 6,950,789, entitled TRAFFIC VIOLATION DETECTION AT AN INTERSECTION EMPLOYING A VIRTUAL VIOLATION LINE, which is expressly incorporated by reference herein.

Referring now to FIG. 3, an exemplary image frame 300, showing the tracking camera field of view (the dotted area 210 of FIG. 2) as the view of the tracking camera 110. From this view, the stop line 150 is clearly visible, as are the vehicles entering the intersection. Note that this exemplary image frame 300 includes three lanes of travel on each side of the road, however the principles and teachings herein are applicable to any number of lanes, as the number of lanes provided herein are for illustrative purposes only because the teachings herein are applicable to an intersection having any number of lanes.

Also note that the image frame 300 of FIG. 3 is only one image frame of a video file that is captured by the camera 110. The other cameras of the illustrative system operate in a similar manner to acquire a digital video file for a traffic violation that is comprised of a series of individual image frames. In particular, the camera for monitoring traffic signals could be a commercial or industrial “off-the-shelf” camera that can produce a continuous stream of video frames at a specified frame rate, such as 15 frames per second (fps), for example. The camera resolution may vary; however at a minimum, each signal disc (i.e. red, yellow, green, red arrow, green arrow, etc.) should cover an image area of at least 20×20 pixels.

Referring now to FIG. 4, the discrete signal camera 120 of FIG. 1 is discussed in further detail. FIG. 4 is a top view of the intersection 100 of roads 101 and 102, according to the illustrative VSS system and method. As shown, the signal camera 120 is directed toward the traffic signal light and the rear of a vehicle as it approaches an intersection. The angle of view of the signal camera 120 spans approximately along arc A2, to provide the signal camera field of view, shown as the shaded region 410 of FIG. 4.

The signal camera provides a recording of vehicles approaching and passing the stop line from the rear in monitored lanes at the time of violations by obtaining a plurality of signal images. This view includes clearly visible signal lights. In an illustrative embodiment, this camera has a clear view from at least approximately 20 feet before the stop line to at least approximately 20 feet after the stop line, and also a clear view of the signal head controlling the monitored lanes. The lower the height for this camera, the better, and is preferably placed at approximately 17 feet, however up to approximately 20 feet is appropriate.

According to the illustrative system of FIG. 4, the single signal camera 120 spans an approximate view along arc A2, providing the field of view 410, having a width W1. Note the width of this view of the signal camera includes the signals 125. According to this embodiment, the camera is programmed so that a boundary box 420 is identified around the light signal head 125 shown within the cameras view. In this manner, these boundary boxes provide the VSS software module (as will be discussed hereinafter in greater detail) with an image of the traffic light signal head, so as to determine the state of the traffic light signal. Alternatively, as will be described in detail below in reference to FIG. 8, the system may employ dual cameras for performing the signal sensing operations, one camera aimed specifically at the signal light head, so as to obtain images of only the signal head.

The signal camera field of view (the shaded region 410 of FIG. 4) is shown in exemplary image frame 500. This view shows the intersection from the rear of a vehicle approaching the intersection, and includes an unobstructed view of the traffic light signal heads. Note the exemplary boundary box 510 that surrounds the signal light head of FIG. 5. As described above, the box defines the boundaries for the portion of the image frame 500 that are transmitted to the processing unit to be used by the VSS software module to determine the state of the signal. In this manner, a single camera is capable of acquiring a video file of a violation event, as well as providing the detailed image of the isolated signal head, as required to determine the state of the traffic signal light. As will be described in greater detail, this image is analyzed by the VSS module using machine vision search techniques to determine the state (i.e. Red, Yellow, or Green).

Referring now to FIG. 6, a top view of the intersection 100 of two roads 101 and 102, showing only the enforcement camera 130 of the illustrative VSS system. The enforcement camera is provided to obtain a recording of the violation vehicle from a close point of view (i.e. zoomed in so as to provide greater detail), so as to provide a plurality of enforcement images, each containing a readable license plate and enough of the vehicle to determine the make of the vehicle. The enforcement camera provides a narrower view that is still sufficient, given the videos and other information captured from the other cameras of the illustrative system. The enforcement camera 130 spans in an approximate angle A3, to provide the enforcement field of view (shaded region 610 of FIG. 6). The shaded region 610 provides the license plate as well as a portion of the vehicle sufficient to identify the vehicle make (i.e. Ford, Chevrolet, GMC, Toyota, etc.), as displayed in FIG. 7.

In an alternate embodiment, the enforcement camera can be located on the opposite side of the intersection 100 than that depicted in FIG. 6, as part of a camera assembly that is rotatably mounted to a pole. This enforcement camera is thus capable of first obtaining images of the front license plate of the vehicle and then swinging approximately 180 degrees as the vehicle exits the intersection and passes by the camera to obtain images of the rear of the vehicle. This provides a more complete piece of evidence for traffic enforcement purposes as the data includes both the front and rear license plates of the vehicle to further support the issuance of a citation. The rotational alignment of the camera on its mount and attitude of the image axis is selected to ensure that the proper view is achieved at each of the opposing rotational orientations.

FIG. 7 shows an exemplary image frame 700, as taken by the enforcement camera 130 of FIG. 6, showing the license plate 710 of the violating vehicle as well as a portion of the vehicle so as to identify its make 720, for example the nameplate containing the word “FORD” in the illustrative image. According to the alternative embodiment, the image frame would include images of not only the rear license plate of the vehicle, but also the front license plate of the vehicle, thereby improving violation accuracy. Furthermore, taking an image of the rear of the vehicle after the vehicle has passed through the intersection further validates the occurrence of a traffic violation, as the image is captured after the violation has already occurred.

Reference is now made to FIG. 8, showing an alternate arrangement of the signal camera of the illustrative VSS system employing two cameras. According to the depicted dual-camera arrangement of FIG. 8, one camera is dedicated solely to obtaining an image of the traffic light signal head exclusively. As shown, signal head camera 810 has a narrow view, resulting in a width ‘W2’, that is significantly narrower than W1 of FIG. 4. This provides a view of only the signal light head to be used as the image for determining the state of the VSS system.

A second camera of the dual camera arrangement, the signal view camera 820, provides a view similar to the signal camera 120 of FIGS. 1 and 4, of the rear of the vehicle, as well as the video signal. It is not necessary to program the camera with a bounding box for the signal light head in this instance, as a dedicated signal head camera 810 gathers this information to determine the state of the signal. The camera need only be installed in the appropriate location to obtain only the traffic light head in its field of view. In this manner, a clear view of the intersection may be obtained by the signal view camera 820, as well as a detailed view of the signal head exclusively by the signal head camera 810.

As described above initially with reference to FIG. 1, the VSS system comprises a plurality of cameras (110, 120 and 130) and a processing unit 175 that receives a video input from the signal camera 120 and runs the VSS software module 180 to determine the state of the traffic signal. The processing unit can be an onboard processor that is directly integrated with the image sensor of the camera (a DSP chip available from National Instruments of Austin, Tex., for example), or can be a single-board computer, or alternatively a regular personal computer (PC). The camera may employ any suitable interface for image transmission and camera control, such as USB, FireWire, CameraLink, or GigE. According to the system, the image frames from each of the video cameras may be in different formats, such as JPEG and bitmap. The VSS software module retrieves images from the camera and performs image processing on these images to determine the active states of the desired signal heads. The VSS module outputs a binary data string that indicates whether a specific signal state is active or not. The process for determining whether a state is active is determined according to the steps illustrated in FIG. 9, now described.

FIG. 9 is a flow diagram showing the overall procedure 900 employed by the video signal sensing (VSS) module in determining the state of the traffic signal. According to the illustrative system, the VSS software module that runs on the processing unit receives images from the signal camera (either from a designated image provided by a bounding box, at step 912, or a designated camera capturing only an image of the traffic signal head, at step 910). The VSS module employs pre-selected coordinates that designate a signal head within each image and at step 920 employs an RGB conversion process that converts these image areas into RGB (red, green and blue) sub-images according to techniques known to those in the art. These coordinates may be specified by a user (i.e. consumer) and identify the location and size of each signal head within the original image frames. Alternatively, these areas can be fairly standardized according to conventional traffic signal head spacing to provide a pre-programmed camera that is capable of detecting each signal head disc located within an image of a traffic signal light.

Next, the VSS software module generally employs procedure step 930, which is a combination of five processes to determine the likelihood, or probability, of each phase being active based on a probability of imaging factors, including hue (at procedure step 931), brightness (932), color intensity (933), shape match (934), and temporal changes (935), as will be described in greater detail below. Each process is adaptive, meaning that it continuously adjusts its parameters based on the image and the recognition results. The probability of each process (931, 932, 933, 934 and 935) is combined by employing a probability combination process at step 940 to produce weighted average probabilities for each signal phase. The weight of each individual process is determined based on recognition performance of its corresponding value from a previous image. Processes that have a better recognition performance will be weighted more than those with a worse recognition performance.

Finally, at step 950, a state determination process is employed that uses the signal phase with the maximum combined probability as being the active state (red, yellow, or green) of the signal light. This can be determined by employing the following formula:

$${s}^{*} = {arg max}_{s} {f}_{combined} ( s ) , \\ s ∈ \{ red , yellow , green \}$$

According to the formula for determining signal head state, f_{combined}(s) is the combined probability for phase ‘s’ and is calculated by performing a weighted average of the probability of all five according to the following formula:

f_{combined}(s)=wₕᵤₑ*fₕᵤₑ(s)+w_{brightness}*f_{brightness}(s)+w_{color}*f_{color}(s)+wₛₕₐₚₑ*fₛₕₐₚₑ(s)+w_{change}*f_{change}(s)

The process by which the probability of each factor, as determined by its respective detector, will now be described. To determine fₕᵤₑ(s), so as to be used in the above equation, according to the hue determination process of step 931, the hue detector calculates an average hue value for all of the pixels within the bounding box (or directed camera) of the target signal head. It also estimates and tracks the average hue value and its variance separately for different signal states (i.e., red, yellow, or green). The Bayesian rule, as formulated in the following equation, calculates the probability of the average hue as representing a particular state of the traffic signal, such as red, yellow, or green:

$${f}_{hue} ( s ) ∝ exp \{ - \frac{{( \overline{h} ( s ) - \overline{h} )}^{2}}{{σ}^{2} ( s )} \}$$

$$s ∈ \{ red , yellow , green \}$$

According to the above equation for calculating hue probability, when the signal s is active, h̅(s) is the average hue value and σ(s) is the hue variance, and their values are estimated in the feedback loop when an active signal determination is made. This occurs, for example, when signal s is active according to the final detector, then the current average hue value is used to update the average hue and its variance for signal s.

To compute the probability for brightness, f_{brightness}(s), the brightness detector, according to the brightness determination process of step 932, first identifies the bright pixels around each signal disc based on its location within the bounding box (or directed camera) of the target signal head and calculates its center of mass and the size of the bright area. Bright pixels are defined as pixels whose intensity values exceed a certain threshold. Once the bright area for each signal disc is identified, its center of mass is compared to the projected center of each signal disc based on the bounding box geometry and a probability value is calculated according to the following formula:

$${f}_{brightness} ( s ) ∝ {\sum }_{j ∈ \{ red , yellow , green \}}^{ } m ( j ) exp \{ - \frac{{( x ( s ) - {x}_{c} ( j ) )}^{2} + {( y ( s ) - {y}_{c} ( j ) )}^{2}}{{σ}_{b}^{2}} \} .$$

According to the above formula for computing f_{brightness}(s), (x_{c}(j), y_{c}(j)) is the center of mass for the bright pixels around signal disc j and m(j) is the corresponding size. According to the configuration, (x(s), y(s)) is the projected center of signal disc j. Note that a signal disc could have no bright area if it is not currently active. In that instance, the corresponding size m(j) would have a value of 0 and thus the probability of brightness would be zero (the state would not be active).

According to the color determination process of step 933, to compute f_{color}(s), the color detector calculates average red, yellow and green values from pixels around the corresponding signal disc. Yellow is calculated as an average from red and green channels. The color probability is then calculated according to the following formula:

$${f}_{color} ( s ) ∝ exp \{ - \frac{\overline{c} ( s )}{{σ}_{c}} \}$$

According to the above color probability formula, c̅(s) is the average red, yellow or green values that correspond to the signal s and σ_{c} is some constant.

To compute the probability of a shape match, fₛₕₐₚₑ(s), the shape detector, according to the shape determination process of step 934, first converts the RGB subimage I_{curr} into a grayscale image and builds a shape model, I(s), for each active signal s using incremental averaging. I(s) represents an average value of how the signal head looks on a grayscale when the signal s is active. Once the shape model, I(s), for each signal is built, it compares the current grayscale image to each shape model and calculates the probability of each state being active based on the difference between the current grayscale image and the shape models, I(s), according to the following formula:

$${f}_{shape} ( s ) ∝ exp \{ - \frac{{\vert {I}_{c} - I ( s ) \vert}^{2}}{{σ}_{s}^{2}} \} .$$

According to the change determination process of step 935, to determine the probability based on temporal changes, f_{change}(s), the change detector first computes an average intensity, ī(s), around each signal disc when in the active state, s, and then estimates an average intensity, ī₀(s), for each signal when it is not active. The change probability is calculated according to the following formula:

$${f}_{change} ( s ) ∝ exp \{ - \frac{{( \overline{i} ( s ) - {\overline{i}}_{0} ( s ) )}^{2}}{{σ}_{c}^{2}} \} .$$

After the probability value for each of the five detectors (931, 932, 933, 934 and 935) are calculated, they are averaged based on their corresponding weights by the combined probability process at step 940 by a combined detector. This produces a combined probability value for each signal and the signal with the greatest combined probability value is selected as the current active signal, s*, to be used in the following formula, also depicted above:

$${s}^{*} = {arg max}_{s} {f}_{combined} ( s ) , \\ s ∈ \{ red , yellow , green \}$$

Once the current active state, s*, is identified, it is compared with the signal with a maximum probability based on each individual detector. If the maximum probability signal, based on an individual detector, agrees with the maximum likelihood signal, based on the combined likelihood, its weight is increased. Otherwise, its weight is decreased. More specifically, for example, for the hue detector, the average hue value for the active signal and its variance will be updated using the current hue value. And for the shape detector, the shape model for the active signal is updated using the current grayscale image. Also, for the change detector, the average intensity values for the non-active signals are updated using the values from the current image.

The foregoing has been a detailed description of illustrative embodiments of the invention. Various modifications and additions can be made without departing from the spirit and scope of this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, the violation event described herein has been related primarily to a vehicle traveling through an intersection after the traffic light has already turned red. However, it is expressly contemplated that this has application in all areas of traffic enforcement, including, but not limited to, any situation in which the action of a drive subsequent to the change of a traffic signal may result in a traffic violation. Also, the depicted images relate to an intersection of two roads, however the teachings herein are applicable to any traffic light having multiple states that a driver and/or vehicle must obey such that a violation of the light results in a citation being issued to the operator. The detected state of the system can, likewise, be limited to those that either do or do not result in a violation (e.g. detect only red or detect only green/yellow). In general, the system and method herein can be implemented as hardware, software consisting of a computer-readable medium executing program instructions, or a combination of hardware and software. Accordingly, this description is meant to be taken only by way of example, and not to otherwise limit the scope of this invention.

What is claimed is:

1. A system for determining an active state of a traffic signal head comprising:
a signal camera adapted to obtain an image of the traffic signal head;
an RGB conversion processing unit adapted to convert the image of the traffic signal head into red, green and blue sub-images; and
a state determination processing unit adapted to select a maximum probability state of the traffic light, having a maximum combined probability based on a plurality of imaging factors, to represent the active state of the traffic signal head.

2. The system of claim 1 wherein the imaging factors comprise a hue of the image of the traffic signal head, a brightness of the image of the traffic signal head, a color of the image of the traffic signal head, a shape of the image of the traffic signal head and a change of the image of the traffic signal head.

3. The system of claim 1 further comprising a hue determination processing unit adapted to determine a hue probability by employing a hue detector to detect an actual hue of the image of the traffic signal head and comparing it to an estimated hue created by the hue determination processing unit.

4. The system of claim 1 further comprising a brightness determination processing unit adapted to determine a brightness probability by employing a brightness detector to detect actual bright pixels around a signal disc located on the traffic signal head to determine an actual center of mass, and compares an estimated center of mass to the actual center of mass.

5. The system of claim 1 further comprising a color determination processing unit adapted to determine a color probability by employing a color detector to detect average red, yellow and green values of each signal disc located on the traffic signal head, and compare an estimated color value to the average values.

6. The system of claim 1 further comprising a shape determination processing unit adapted to determine a shape probability by converting the RGB sub-image into a grayscale image, and compare the grayscale image to an estimated grayscale image.

7. The system of claim 1 further comprising a change determination processing unit adapted to determine a change probability by detecting an intensity for each signal disc located on the traffic signal head, and compares it to an estimated average intensity for each signal disc.

8. A method for determining a state of the traffic signal head, the traffic signal head comprising a plurality of signal discs that represent an active state of the traffic signal head, the method comprising:
obtaining an image of the traffic signal head from a signal sensing traffic enforcement camera;
converting the image of the traffic signal head into a plurality of sub-images; and
selecting a maximum combined probability state, having a maximum combined probability based on a plurality of imaging factors, as the active state of the traffic signal head.

9. The method of claim 8 wherein the sub-images comprise a plurality of grayscale sub-images.

10. The method of claim 8 wherein the sub-images comprise a plurality of RBG sub-images.

11. The method of claim 10 further comprising determining a hue probability by employing a hue detector to detect an actual hue of the image of the traffic signal head and comparing it to an estimated hue created by the hue determination process.

12. The method of claim 10 further comprising determining a brightness probability by employing a brightness detector to detect actual bright pixels around a signal disc located on the traffic signal head to determine an actual center of mass, and compares an estimated center of mass to the actual center of mass.

13. The method of claim 10 further comprising determining a color probability by employing a color detector to detect average red, yellow and green values of each signal disc located on the traffic signal head, and comparing an estimated color value to the average values.

14. The method of claim 10 further comprising determining a shape probability by converting the RGB sub-image into a grayscale image, and comparing the grayscale image to an estimated grayscale image.

15. The method of claim 10 further comprising determining a change probability by detecting an intensity for each signal disc located on the traffic signal head, and comparing it to an estimated average intensity for each signal disc.

16. A system for detecting a violation of a traffic signal light comprising:
a tracking camera system that monitors at least one vehicle as the at least one vehicle approaches an intersection, including a tracking process that views and images the at least one vehicle as it enters the intersection, wherein the tracking process is constructed and arranged to determine if the violation has occurred, and in response to the violation occurrence, captures tracking images of the violation;
a signal camera system that obtains a signal image of the traffic signal light, wherein the signal camera is operatively connected to a processing unit that includes a video signal-sensing process to determine a state of the traffic signal light; and
an enforcement camera system that obtains at least one enforcement image, the at least one enforcement image containing an image of a license plate of the at least one vehicle.

17. The system of claim 16 wherein the enforcement camera system includes an enforcement camera that is pivotally mounted to a pole at the intersection so as to obtain enforcement images of a front license plate of the vehicle and thereafter pivot to an orientation adapted to obtain enforcement images of a rear license plate of the vehicle.

18. The system of claim 16 further comprising an RGB conversion process that converts the signal image into red, green and blue sub-images.

19. The system of claim 16 further comprising a state determination process that selects a maximum probability state of the traffic light, having a maximum combined probability based on hue, brightness, color, shape and change of the signal image, to represent an active state of the traffic signal light.

20. The system of claim 16 wherein the signal camera system includes at least two cameras including a first camera constructed and arranged to acquire an image of the traffic signal light exclusively, and a second camera constructed and arranged to acquire an image of an event of the traffic violation.
